(19) United States
(12) Patent Application Publication
(10) Pub. No.: US 2026/0290227 A1
(43) Pub. Date: Sep. 24, 2026

(54) DISPLAY PANEL AND DISPLAY APPARATUS

(71) Applicant: WuhanTianmaMicroelectronicsCo.,Ltd., Wuhan (CN)

(72) Inventors: Kang YANG, Wuhan (CN); Qiaoling ZHANG, Wuhan (CN); De KANG, Wuhan (CN); Junhong PAN, Wuhan (CN); Jin GUO, Wuhan (CN); Zhihua YU, Wuhan (CN); Chuan LIU, Wuhan (CN); Jun LI, Wuhan (CN); Kangpeng YANG, Wuhan (CN)

(73) Assignee: WuhanTianmaMicroelectronicsCo.,Ltd., Wuhan (CN)

(21) Appl. No.: 19/570,193

(22) Filed: Mar. 18, 2026

(30) Foreign Application Priority Data
Mar. 18, 2025 (CN) 202510322907.8

(51) Int. Cl. G09G 3/32; G09G 3/3225

(52) U.S. Cl. CPC G09G 3/32; G09G 3/3225; G09G 2300/0426; G09G 2300/0452; G09G 2320/0242; G09G 2330/021; G09G 2330/08

(57) ABSTRACT

The present application discloses a display panel and a display apparatus. The display panel includes data signal lines, sub-pixels, data source lines, and a multiplexer circuit; the data signal lines extend along a first direction and are arranged along a second direction intersecting with the first direction, and are electrically connected to the sub-pixels; the data source lines extend along the first direction and are arranged along the second direction; the multiplexer circuit includes gating units each include one input terminal and N output terminals, the input terminals of the gating units are electrically connected to the data source lines, the N output terminals of each gating unit are electrically connected to N of the data signal lines, respectively, N≥2; and at least one the gating units satisfies a case that the N of the data signal lines are electrically connected to sub-pixels of a same color.

### CROSS-REFERENCE TO RELATED APPLICATIONS

The present application claims priority to Chinese Patent Application No. 202510322907.8 filed on Mar. 18, 2025, and titled “DISPLAY PANEL AND DISPLAY APPARATUS”, which is incorporated herein by reference in its entirety.

### TECHNICAL FIELD

The present application relates to the field of display technology, and particularly, to a display panel and a display apparatus.

### BACKGROUND

With the continuous development of electronic information technology, display devices (such as smart phones, tablet computers, and the like) have been more and more widely used, and play an indispensable role in people's work and life. Therefore, with the continuous development of the display devices, users' requirements for the battery life of the display devices have been getting higher and higher, so that the technical problem to be solved urgently at present is how to increase the battery life of the display devices.

### SUMMARY

The present application provides a display panel and a display apparatus.

According to one aspect of the present application, a display panel is provided, and the display panel includes:
a plurality of data signal lines and a plurality of sub-pixels, the plurality of data signal lines extending along a first direction and being arranged along a second direction, the first direction intersecting with the second direction, and the data signal lines being electrically connected to the plurality of sub-pixels;
a plurality of data source lines extending along the first direction and arranged along the second direction;
a multiplexer circuit including a plurality of gating units which each include one input terminal and N output terminals, the input terminals of the gating units being electrically connected to the data source lines, and the N output terminals of each of the gating units being electrically connected to N of the data signal lines, respectively, N≥2; and
at least one of the gating units satisfying a case that the N of the data signal lines are electrically connected to a plurality of the sub-pixels of a same color.

According to the other aspect of the present application, a display apparatus which includes the display panel as previously described is provided.

It should be understood that the content which is described in this section is neither intended to identify key or important features of the embodiments of the present application nor limit the scope of the present application. Other features of the present application will become readily understood from the following description.

### BRIEF DESCRIPTION OF THE DRAWINGS

In order to more clearly illustrate the technical solutions of the embodiments of the present application, the drawings to be used in the embodiments of the present application will be briefly introduced below. It is obvious that the drawings described below are merely some embodiments of the present application, and for those of ordinary skill in the art, other drawings can be obtained based on these drawings without inventive effort.

FIG. 1 is a schematic view of a display panel according to embodiments of the present application;

FIG. 2 is a schematic view of a sub-pixel according to embodiments of the present application;

FIG. 3 is a time sequence diagram of the display panel shown in FIG. 1;

FIG. 4 is a schematic view of another display panel according to embodiments of the present application;

FIG. 5 is a schematic view of yet another display panel according to embodiments of the present application;

FIG. 6 is a schematic view of yet another display panel according to embodiments of the present application;

FIG. 7 is a time sequence diagram of the display panel shown in FIG. 6;

FIG. 8 is a schematic view of yet another display panel according to embodiments of the present application;

FIG. 9 is a time sequence diagram of the display panel shown in FIG. 8;

FIG. 10 is a schematic view of yet another display panel according to embodiments of the present application;

FIG. 11 is a time sequence diagram of the display panel shown in FIG. 10;

FIG. 12 is a schematic view of yet another display panel according to embodiments of the present application;

FIG. 13 is a time sequence diagram of the display panel shown in FIG. 12;

FIG. 14 is a schematic view of yet another display panel according to embodiments of the present application;

FIG. 15 is a schematic view of a redundant gating unit according to embodiments of the present application;

FIG. 16 is a schematic view of another redundant gating unit according to embodiments of the present application;

FIG. 17 is a schematic view of yet another redundant gating unit according to embodiments of the present application; and

FIG. 18 is a schematic view of a display apparatus according to embodiments of the present application.

### DETAILED DESCRIPTION

Technical solutions of embodiments of the present application will be described clearly and completely with reference to drawings in the embodiments of the present application. Obviously, the described embodiments are a part of the embodiments of the present application, but not all of the embodiments. Based on the embodiments of the present application, all other embodiments obtained by those ordinary skilled in the art without any creative work shall fall within the protection scope of the present application.

It should be noted that the terms “first”, “second” and the like in the description, claims and the above description of the drawings of the present application are used for distinguishing similar objects, and not necessarily for describing a specific order or priority in order. It should be understood that the data used in this manner may be interchangeable where appropriate, so that the embodiments of the the present application described herein can be implemented in other orders than those illustrated or described herein. Moreover, the terms “comprising” and “including” and any variations thereof are intended to cover a non-exclusive inclusion (such as a process, method, system, product, or device including a series of steps or units), and are not necessarily limited to those steps or units which are listed clearly, but may include other steps or units which are not clearly listed or inherent to such processes, methods, products, or devices.

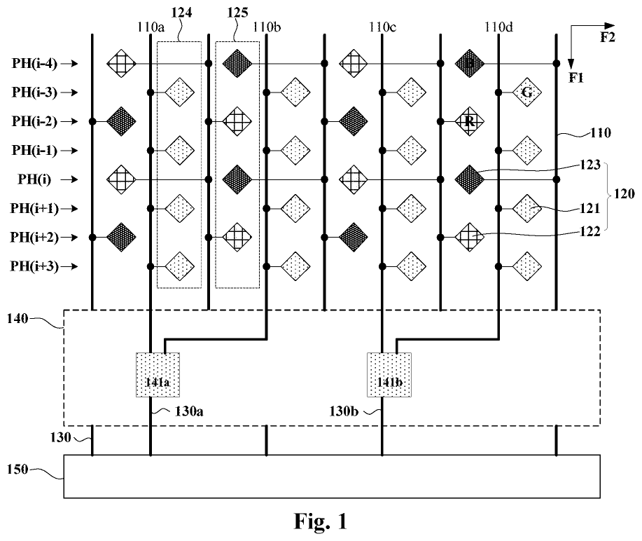

FIG. 1 is a schematic view of a display panel according to embodiments of the present application. As shown in FIG. 1, the display panel includes, a plurality of data signal lines 110, a plurality of sub-pixels 120, a plurality of data source lines 130, and the multiplexer circuit 140; the plurality of data signal lines 110 extend along the first direction F1 and are arranged along the second direction F2, the first direction F1 intersects with the second direction F2, and the data signal lines 110 are electrically connected to the plurality of sub-pixels 120; the plurality of data source lines 130 extend along the first direction F1 and are arranged along the second direction F2; the multiplexer circuit 140 includes a plurality of gating units 141 which each include one input terminal and N output terminals, the input terminals of the gating units 141 are electrically connected to the data source lines 130, the N output terminals of each of the gating units 141 are electrically connected to N of the data signal lines 110, respectively, and N≥2; at least one of the gating units 141 satisfies the case that the N of the data signal lines 110 are electrically connected to a plurality of the sub-pixels 120 of the same color. It should be noted that, in FIG. 1, the specific structure of the display panel is not shown, the connection relationship of the components in the local areas of the display panel is illustrated only by simple lines, wireframes, or the like, and the actual layout design of the display panel is not limited thereto. N is an integer.

In one embodiment, the display panel includes the plurality of sub-pixels 120. The plurality of sub-pixels 120 of the display panel include a plurality of types of sub-pixels 120 of different light-emitting colors. Optionally, the plurality of sub-pixels 120 include the first color sub-pixels 121, the second color sub-pixels 122, and the third color sub-pixels 123 of different colors. Specifically, the plurality of sub-pixels 120 of the display panel include three types of sub-pixels 120 of different light-emitting colors, that is, the first color sub-pixels 121 whose light-emitting color is the first color, the second color sub-pixels 122 whose light-emitting color is the second color, and the third color sub-pixels 123 whose light-emitting color is the third color, and the light-emitting colors of any two of the first color, the second color, and the third color are different from each other. In other embodiments, optionally, the plurality of sub-pixels of the display panel may further include two or three or more types of sub-pixels of different light-emitting colors. The type of the light-emitting colors, the arrangement of light-emitting colors and the light-emitting types of the sub-pixels in the display panel are not specifically limited by the present application, which is applied in a plurality of different types of display panels.

Optionally, the display panel includes the red sub-pixels, the green sub-pixels, and the blue sub-pixels of different light-emitting colors, and the first color sub-pixels 121, the second color sub-pixels 122, and the third color sub-pixels123 are the red sub-pixels, the green sub-pixels, and the blue sub-pixels, respectively. In an example, referring to FIG. 1, optionally, the first color sub-pixels 121 are the green sub-pixels G, the second color sub-pixels 122 are the red sub-pixels R, and the third color sub-pixels 123 are the blue sub-pixels B, but the arrangement of the light-emitting colors of the first color sub-pixels, the second color sub-pixels, and the third color sub-pixels is not limited by the present application. In other embodiments, optionally, i the first color sub-pixels are the blue sub-pixels, and the second color sub-pixels and the third color sub-pixels are the red sub-pixels and the green sub-pixels, respectively; or the first color sub-pixels are the red sub-pixels, and the second color sub-pixels and the third color sub-pixels are the green sub-pixels and the blue sub-pixels, respectively; or the sub-pixels of the display panel may have other types and arrangements of light-emitting colors, and those skilled in the art may properly design the types and the arrangements of the light-emitting colors of the sub-pixels based on the requirements for the product.

The display panel includes the plurality of data signal lines 110 which extend along the first direction F1 and are arranged along the second direction F2. One data signal line 110 is electrically connected to a plurality of the sub-pixels 120 and is used for providing the data signal to the corresponding sub-pixels 120 which are electrically connected thereto, achieving light-emitting driving of the sub-pixels 120 and ensuring light-emitting display of the sub-pixels 120. Specifically, the sub-pixels 120 each include the pixel circuit and the light-emitting element which are electrically connected to each other, and the data signal line 110 is electrically connected to the pixel circuits of the sub-pixels 120 to provide the data signal to the pixel circuits, thereby achieving the light-emitting driving of the light-emitting elements of the sub-pixels 120.

In the sub-pixels 120, the light-emitting elements are provided variously, and the pixel circuits are also provided variously. In an example, the light-emitting elements each include the organic light-emitting diode, or the micro light-emitting diode Micro LED, or the sub-millimeter light-emitting diode Mini LED, or the like, which is not limited thereto. In an example, the pixel circuits may be “7T1C”, or “8T1C”, or “8T2C”, or the like, which is not limited thereto; “T” represents the transistor, and “C” represents the storage capacitor. In this embodiment, the example in which the pixel circuits are “7T1C” is given for illustrating the electrical connection relationship of the data signal lines 110 and the sub-pixels 120, and the pixel circuits may be adaptively adjusted by those skilled in the art based on on the requirements and are not limited to “7T1C”.

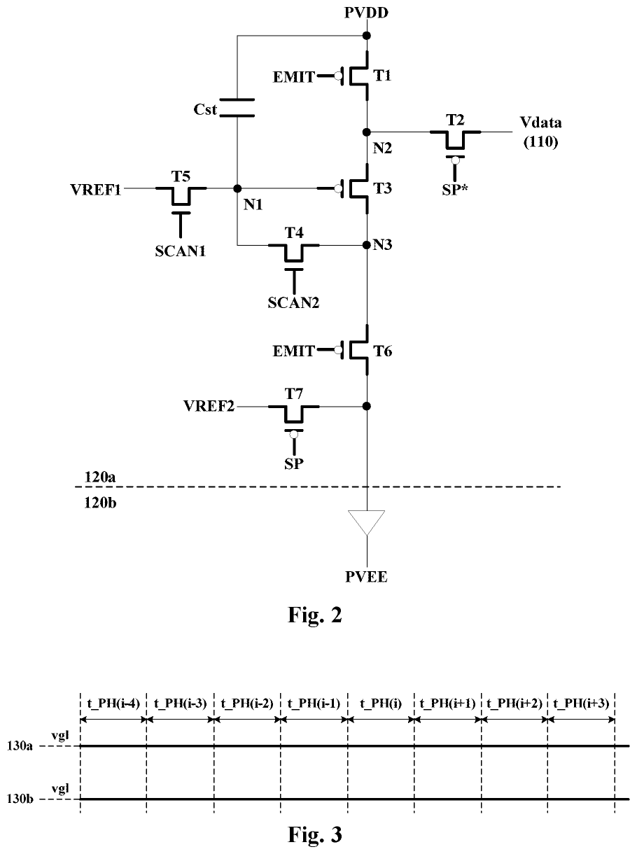

FIG. 2 is a schematic view of a sub-pixel according to embodiments of the present application. As shown in FIG. 2, the sub-pixel 120 includes the pixel circuit 120a and the light-emitting element 120b. The pixel circuit 120a includes the first adjusting transistor T1, the data writing transistor T2, the driving transistor T3, the threshold compensation transistor T4, the initialization transistor T5, the second adjusting transistor T6, the reset transistor T7, and the storage capacitor Cst. The data signal line 110 is electrically connected to the input terminal of the data writing transistor T2 of the pixel circuit 120a, and provides the data signal Vdata to the data writing transistor T2 of the pixel circuit 120a.

In the operation process of the pixel circuit 120a, the signal which is provided by the scanning signal line SCAN1 may control the initialization transistor T5 to be turned on or turned off, and the initialization signal which is provided by the initialization signal line VREF1 resets the gate N1 of the driving transistor T3 by the initialization transistor T5 which is turned on. The signal which is provided by the scanning signal line SP* may control the data writing transistor T2 to be turned on or turned off, and the data signal Vdata which is provided by the data signal line 110 is written to the driving transistor T3 by the data writing transistor T2 which is turned on. The signal which is provided by the scanning signal line SCAN 2 may control the threshold compensation transistor T4 to be turned on or turned off; when the threshold compensation transistor T4 is turned on, the pixel circuit 120a may compensate the threshold voltage of the driving transistor T3. The signal of the node N1 may control the driving transistor T3 to be turned on or turned off. The signal which is provided by the scanning signal line SP may control the reset transistor T7 to be turned on or turned off, and the reset signal which is provided by the reset signal line VREF2 resets the anode of the light-emitting element 120b by the reset transistor T7 which is turned on. The signal which is provided by the light adjusting control signal line EMIT may control the first light adjusting transistor T1 and the second light adjusting transistor T6 to be turned on or turned off, and the power supply signal which is provided by the power supply signal line PVDD is transmitted to the light-emitting element 120b by the first light adjusting transistor T1 and the second light adjusting transistor T6 which are turned on. Based on this, a plurality of signal lines of the display panel provide the signals to the pixel circuits 120a to drive the pixel circuits 120a, thereby achieving the light-emitting driving of the light-emitting elements 120b. The plurality of signal lines of the display panel include the data signal lines 110. Optionally, the scanning signal line SP and the scanning signal line SP* may be the same signal line. Optionally, in other embodiments, the scanning signal line SP and the scanning signal line SP* may be two different signal lines.

The display panel further includes a plurality of data source lines 130 and a multiplexer circuit 140, the data source lines 130 extend along the first direction F1, and the plurality of data source lines 130 are arranged along the second direction F2. The multiplexer circuit 140 includes a plurality of input terminals and a plurality of output terminals, the plurality of input terminals of the multiplexer circuit 140 are electrically connected to the plurality of data source lines 130, respectively, and the plurality of output terminals of the multiplexer circuit 140 are electrically connected to the plurality of data signal lines 110, respectively. Specifically, the multiplexer circuit 140 includes a plurality of gating units 141 which each include one input terminal and N output terminals, the input terminals of the gating units 141 are electrically connected to the data source lines 130, the N output terminals of each of the gating units 141 are electrically connected to N of the data signal lines 110, respectively, and N≥2 Based on this, the number of the input ports of the multiplexer circuit 140 is less than the number of the output ports of the multiplexer circuit 140, and the display panel may control the input terminal and the N output terminals of each of the gating units 141 to be turned on in a time-shared manner, so that one data source line 130 may provide corresponding data signals to the corresponding N of the data signal lines 110 by the gating unit 141 in a time-shared manner. It may be understood that the data signals which are provided by the one data source line 130 to the corresponding N of the data signal lines 110 in a time-shared manner may be the same or different one another.

Optionally, only two gating units 141 are shown in the multiplexer circuit 140 in FIG. 1, and the only two gating units 141 are the gating unit 141a and the gating unit 141b, respectively. Optionally, in FIG. 1, N=2, the input terminal of the gating unit 141a is electrically connected to the data source line 130a, two output terminals of the gating unit 141a are electrically connected to the data signal line 110a and the data signal line 110b, respectively; the input terminal of the gating unit 141b is electrically connected to the data source line 130b, and two output terminals of the gating unit 141b are electrically connected to the data signal line 110c and the data signal line 110d, respectively. It may be understood that the multiplexer circuit 140 further includes a plurality of other gating units 141, and/or N is greater than 2, which is not specifically shown in this embodiment. Further, in the display panel shown in FIG. 1, the shown five of the data source lines 130 may be electrically connected to at least nine of the data signal lines 110 by five of the gating units 141, which is not limited thereto.

The display panel includes the driver chip 150 which provides the data signals to the data signal lines 110, the driver chip 150 includes a plurality of data signal ports which correspond to the plurality of data source lines 130, respectively, one data signal port of the driver chip 150 provides the data signals to one corresponding data source line 130, and the data source lines 130 provide the data signals to the N data signal lines 110 by the gating units 141. In the display panel, providing the multiplexer circuit 140 may achieve driving of the the plurality of data signal lines 110 by one data source line 130. The number of the data source lines 130 is smaller than the number of the data signal lines 110, and the number of the data signal ports of the driver chip 150 is correspondingly reduced, so that the cost of the display panel may be reduced.

In the multiplexer circuit 140, at least one of the gating units 141 satisfies the case that the N of the data signal lines 110 each are electrically connected to a plurality of the sub-pixels 120 of the same color. In this embodiment, an example in which at least N of the data signal lines 110 each are electrically connected only to a plurality of the first color sub-pixels 121 of the same light-emitting color is given for describing the connection relationship of the data signal lines 110, the gating unit 141, and the data source line 130 and the operation principle of the display panel; at least N of the data signal lines 110 include the data signal line 110a, the data signal line 110b, the data signal line 110c, and the data signal line 110d.

Referring to FIG. 1, optionally, the display panel includes a plurality of first pixel columns 124 which are arranged along the second direction F2, and the first pixel columns 124 each are formed by the plurality of the first color sub-pixels 121 which are arranged along the first direction F1. It may be understood that the first pixel columns 124 each only include the plurality of the first color sub-pixels 121; the second-type pixel columns 125 each are provided between adjacent two of the first pixel columns 124, the second-type pixel columns 125 each include a plurality of the sub-pixels 120 which are arranged along the first direction F1, and the light-emitting color of at least one of the sub-pixels 120 in each of the second-type pixel columns 125 is different from the light-emitting color of the first color sub-pixels 121. In this embodiment, optionally, the second-type pixel columns 125 each include the second color sub-pixels 122 and the third color sub-pixels 123 which are alternately arranged, but the pixel arrangement of the display panel is not limited thereto, and the display panel with different pixel layouts will be described in detail in a plurality of subsequent embodiments.

In the display panel, optionally, the data signal line 110a is electrically connected to the corresponding one of the first pixel columns 124, the data signal line 110b is electrically connected to the corresponding one of the first pixel columns 124, the data signal line 110c is electrically connected to the corresponding one of the first pixel columns 124, and the data signal line 110d is electrically connected to the corresponding one of the first pixel columns 124.

Therefore, it may be known that, in the multiplexer circuit 140, two data signal lines 110a and 110b which are electrically connected to the gating unit 141a both provide the data signals to the plurality of the first-color sub-pixels 121 of the same light-emitting color; the data source line 130a provides the data signals to only the plurality of the first color sub-pixels 121 by the gating unit 141a to drive only the first color sub-pixels 121 to emit light and display. And/or, two data signal lines 110c and 110d which are electrically connected to the gating unit 141b both provide the data signals to the plurality of the first-color sub-pixels 121 of the same light-emitting color; the data source line 130b provides the data signals to only the plurality of the first color sub-pixels 121 by the gating unit 141b to drive only the first color sub-pixels 121 to emit light and display.

It may be known that, in the multiplexer circuit 140, N of the data signal lines 110 (such as 110a and 110b) which are electrically connected to the gating unit 141a each are electrically connected to a plurality of the sub-pixels 120 of the same color, and N of the data signal lines 110 (such as 110c and 110d) which are electrically connected to the gating unit 141b each are electrically connected to a plurality of the sub-pixels 120 of the same color.

FIG. 3 is a time sequence diagram of the display panel shown in FIG. 1. Herein, only the example in which the display panel displays the first color image is given for illustration. Optionally, when the display panel displays the first color image, the first color sub-pixels 121 in the display panel are driven to emit light. Optionally, the low level vgl is used for charging the first color sub-pixels 121, and the high level is used for charging the second color sub-pixels 122 and the third color sub-pixels 123. Referring to FIG. 1 and FIG. 3, optionally, the display panel includes a plurality of pixel rows which include at least the pixel rows from PH (i−4) to PH (i+3), (i−4) is greater than or equal to 1, and t_PH (i) characterizes the starting stage of the i-th pixel row PH (i) herein.

Specifically, when the first color image is displayed, and any row of sub-pixels 120 are charged, since the data signal line 110a, the data signal line 110b, the data signal line 110c, and the data signal line 110d are all electrically connected only to the plurality of first color sub-pixels 121 of the same light-emitting color, the data signal line 110a, the data signal line 110b, the data signal line 110c, and the data signal line 110d may be constantly maintained to output the low level to charge the first color sub-pixels 121 without affecting the process for charging the sub-pixels of other colors. Accordingly, when the first color image is displayed, the data source line 130a is maintained to output the low level, thereby providing the low level signal to the data signal line 110a and the data signal line 110b in a time-sharing manner by the gating unit 141a to charge the first color sub-pixels 121; Similarly, the data source line 130b is maintained to output the low level, thereby providing the low level signal to the data signal line 110c and the data signal line 110d in a time-sharing manner by the gating unit 141b to charge the first color sub-pixels 121.

In this embodiment, optionally, the i-th pixel row PH (i) does not include the first color sub-pixels 121, and the (i+1)-th pixel row PH (i+1) includes the first color sub-pixels 121. The starting stage of the i-th pixel row PH (i) is taken as an example herein.

In an example, when the first color image is displayed, the i-th pixel row PH (i) is controlled to be turned on, that is, the i-th pixel row PH (i) enters the stage t_PH (i); in the stage t_PH (i), the data source line 130a and the data source line 130b are both maintained to output the low level, so that the data signal line 110a, the data signal line 110b, the data signal line 110c, and the data signal line 110d are maintained at the low level; and since the data signal line 110a, the data signal line 110b, the data signal line 110c, and the data signal line 110d are all electrically connected only to the plurality of first color sub-pixels 121 of the same light-emitting color, the low levels of the data source line 130a and the data source line 130b do not affect the high level charging process for the second color sub-pixels 122 and the third color sub-pixels 123 in the i-th pixel row PH (i). Sequentially, the (i+1)-th pixel row PH (i+1) is controlled to be turned on, that is, the (i+1)-th pixel row PH (i+1) enters the stage t_PH (i+1); in the stage t_PH (i+1), the data source line 130a and the data source line 130b are both maintained to output the low level, so that the data signal line 110a, the data signal line 110b, the data signal line 110c, and the data signal line 110d are maintained at the low level, then the plurality of the first color sub-pixels 121 in the (i+1) th pixel row PH (i+1) can be charged. Similarly, in the process of displaying the first color image, the data source line 130a and the data source line 130b may be constantly maintained to output the low level, thereby achieving the display of the first color image by the display panel.

As described above, when the first color image of the solid color is displayed, the driver chip 150 controls the data source line 130a and the data source line 130b to be maintained to output the fixed low level, then the frequent level conversion is not required for the plurality of the data source lines 130 which are electrically connected to the first color sub-pixels 121, so that the loss which is caused by the level conversion in the data source lines in the solid color image may be reduced, achieving the low power consumption for the display panel.

In other embodiments, optionally, the multiplexer circuit has at least two types of gating units; a plurality of the data signal lines which are electrically connected to the first-type gating unit are all used for driving the first color sub-pixels of the same light-emitting color, and a plurality of the data signal lines which are electrically connected to the second-type gating unit are all used for driving the second color sub-pixels of the same light-emitting color. Or, in other embodiments, optionally, the multiplexer circuit has at least three types of gating units; a plurality of the data signal lines which are electrically connected to the first-type gating unit are all used for driving first color sub-pixels of the same light-emitting color, a plurality of the data signal lines which are electrically connected to the second-type gating unit are all used for driving the second color sub-pixels of the same light-emitting color, and a plurality of the data signal lines which are electrically connected to the third-type gating unit are all used for driving the third color sub-pixels of the same light-emitting color. In the present application, the structures of the multiplexer circuit, the data source lines, and the data signal lines may be properly designed, and the data signal lines for driving the sub-pixels of the same color are combined, so that the same data source line is electrically connected to the plurality of the data signal lines for driving the sub-pixels of the same color by the gating unit; in this way, times for charging and discharging the data signal lines in the solid color image may be reduced, and the power consumption of the display panel may be reduced while ensuring the display effect. Further, the power consumption for charging the data signal lines may be reduced, which may contribute to the duration for charging the data signal lines to a certain extent, that is, the duration for charging the data signal lines may be increased.

In the present application, by designing the connection relationship between the gating unit and the data signal lines, N output terminals of the same gating unit are electrically connected to N of the data signal lines, respectively, and the N of the data signal lines drive the plurality of the sub-pixels of the same light-emitting color; then one data source line may be electrically connected to N of the data signal lines by the gating unit, and the N of the data signal lines drive the plurality of the sub-pixels of the same light-emitting color. Based on this, when the solid color image is displayed, the frequent level conversion is not required for at least one of the data source lines in the display panel, so that the loss which is caused by the level conversion in the data source lines in the solid color image may be reduced, the goal of reducing the power consumption of the display panel is achieved while not affecting the display image quality of the display panel, and the display effect is maintained, increasing the battery life of the display device.

Optionally, the multiplexer circuit includes a plurality of gating control lines; the gating units each include N switching elements, the input terminals of the switching elements are electrically connected to the data source lines, the output terminals of the switching elements are electrically connected to the data signal lines, and the control terminals of the switching elements are electrically connected to the gating control lines; the plurality of gating control lines are used for controlling the N switching elements of each of the gating units to be turned on in a time-sharing manner. Optionally, the multiplexer circuit includes the first one to the N-th one of the gating control lines; the gating units each include the first one to the N-th one of the switching elements; the control terminals of the i-th switching elements of the plurality of gating units are electrically connected to the i-th gating control line, and 1≤i≤N. Optionally, the i-th switching elements of the plurality of gating units which are electrically connected to the i-th gating control line are the N-type transistors; or the i-th switching elements of the plurality of gating units which are electrically connected to the i-th gating control line are the P-type transistors. i is an integer.

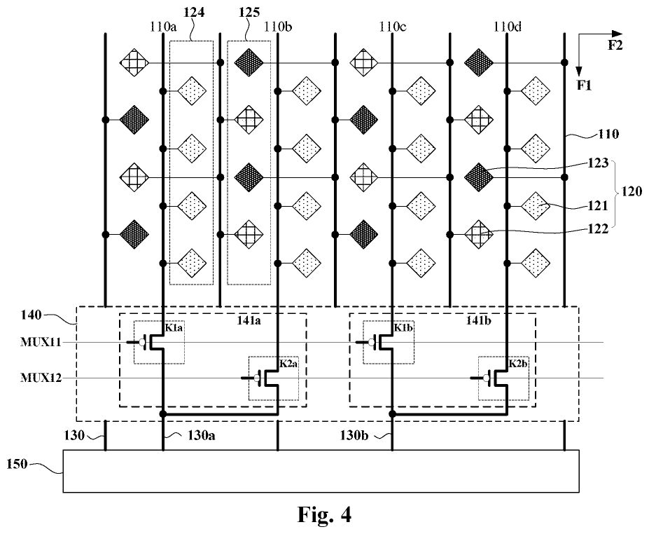

FIG. 4 is a schematic view of another display panel according to embodiments of the present application. As shown in FIG. 4, optionally, N=2. In this embodiment, optionally, the multiplexer circuit 140 includes two gating control lines MUX which are the first gating control line MUX 11 and the second gating control line MUX 12, respectively. The gating units 141 each include two switching elements K which are the first switching element K1 and the second switching element K2. In each of the gating units 141, the control terminal of the first switching element K1 is electrically connected to the first gating control line MUX 11, the control terminal of the second switching element K2 is electrically connected to the second gating control line MUX 12, the input terminal of the first switching element K1 and the input terminal of the second switching element K2 are electrically connected to the same data source line 130, and the output terminal of the first switching element K1 and the output terminal of the second switching element K2 are electrically connected to different two of the data signal lines 110. Under the control of two gating control lines MUX, two switching elements K in each of the gating units 141 are turned on in a time-sharing manner, then the same data source line 130 outputs the data signals to two data signal lines 110 by the gating unit 141 in a time-sharing manner. It should be noted that the number of gating control lines may be equal to or different from N. In an example, in a 1:2 MUX, optionally, there are 2 or 4 gating control lines. In 1:3 MUX, optionally, there are 3 or 6 gating control lines. In this embodiment, a 1:2 MUX includes two gating control lines as an example.

Optionally, a plurality of switching elements K which are electrically connected to the same gating control line MUX are all the same type of transistors. Under the control of a plurality of gating control lines MUX, optionally, the operation stage of the gating units 141 includes the first one to the N-th one of the gating stages; in the i-th gating stage of the gating units 141, the i-th gating control line controls the i-th switching element of each of the gating units 141 to be turned on.

Referring to FIG. 4, optionally, a plurality of first switching elements K1 which are electrically connected to the first gating control line MUX 11 are all the same P-type transistors; and, optionally, a plurality of second switching elements K2 which are electrically connected to the second gating control line MUX 12 are all the same P-type transistors.

The operation stages of the gating units 141 include the first gating stage and the second gating stage. The details are as follows.

In the first gating stage, the first gating control line MUX 11 provides the low level, and the second gating control line MUX 12 provides the high level, then the first switching element K1a of the gating unit 141a is turned on to transmit the data signal of the data source line 130a to the data signal line 110a, and the first switching element K1b of the gating unit 141b is turned on to transmit the data signal of the data source line 130b to the data signal line 110c.

In the second gating stage, the first gating control line MUX 11 provides the high level, and the second gating control line MUX 12 provides the low level, then the second switching element K2a of the gating unit 141a is turned on to transmit the data signal of the data source line 130a to the data signal line 110b, and the second switching element K2b of the gating unit 141b is turned on to transmit the data signal of the data source line 130b to the data signal line 110d.

Optionally, when the display panel displays the first color image of the solid color, the first color sub-pixels 121 in the display panel are driven to emit light. Optionally, the low level is used for charging the first color sub-pixels 121, and the high level is used for charging the second color sub-pixels 122 and the third color sub-pixels 123. Referring to FIG. 3 and FIG. 4, when any row of sub-pixels 120 are charged, only the plurality of data signal lines 110 which are electrically connected to the first color sub-pixels 121 may be maintained to output the low level constantly to charge the first color sub-pixels 121 in the plurality of pixel rows without affecting the process for charging the sub-pixels of other colors. Accordingly, the frequent level conversion is not required for the plurality of data source lines 130 which are electrically connected to the first color sub-pixels 121, so that the loss which is caused by the level conversion in the data source lines in the solid color image may be reduced, achieving the low power consumption for the display panel.

In other embodiments, optionally, the i-th switching element of each of the plurality of gating units which is electrically connected to the i-th gating control line is the N-type transistor; in the i-th gating stage, the i-th gating control line provides the high level, and the i-th gating control line controls the i-th switching element of each of the plurality of gating units which is electrically connected to the i-th gating control line to be turned on.

Optionally, N switching elements of each of the gating units are electrically connected to Q gating control lines of the multiplexer circuit, respectively, and Q≤N. In this embodiment, N switching elements of each of the gating units may be controlled by Q gating control lines, and Q may be less than N. In other embodiments, optionally, Q=N (as shown in FIG. 4). Q is an integer and greater than or equal to 1.

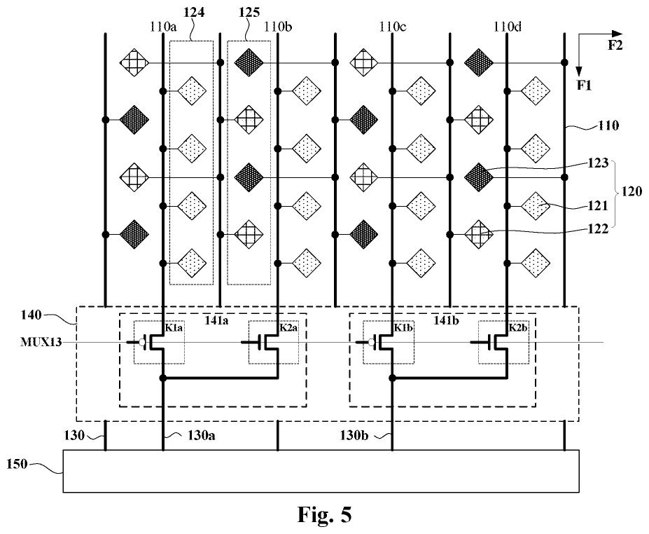

FIG. 5 is a schematic view of yet another display panel according to embodiments of the present application. FIG. 5 is different from FIG. 4 in that N switching elements K of each of the gating units 141 in FIG. 5 include at least one N-type transistor and at least one P-type transistor. In each of the gating units141, one N-type transistor and one P-type transistor may be controlled by the same gating control line MUX.

Referring to FIG. 5, optionally N=2, the multiplexer circuit 140 includes at least one gating control line MUX 13; the gating units 141 each include two switching elements K. Specifically, in the gating unit 141a, the control terminal of the switching element K1a and the control terminal of the switching element K2a are both electrically connected to the gating control line MUX 13, the input terminal of the switching element K1a and the input terminal of the switching element K2a are both electrically connected to the data source line 130a, the output terminal of the switching element K1a is electrically connected to the data signal line 110a, and the output terminal of the switching element K2a is electrically connected to the data signal line 110b. In the gating unit 141b, the control terminal of the optical switching element K1b and the control terminal of the switching element K2b are both electrically connected to the gating control line MUX 13, the input terminal of the switching element K1b and the input terminal of the switching element K2b are both electrically connected to the data source line 130b, the output terminal of the switching element K1b is electrically connected to the data signal line 110c, and the output terminal of the switching element K2b is electrically connected to the data signal line 110d. The gating control line MUX 13 is used for controlling two switching elements K1 and K2 in each of the gating units 141 to be turned on in time-sharing manner, then the same data source line 130 outputs the data signals to different two of the data signal lines 110 by the gating unit 141 in time-sharing manner.

Referring to FIG. 5, optionally, the first switching element K1 of each of the gating units 141 includes the P-type transistor, and the second switching element K2 of each of the gating units 141 includes the N-type transistor.

The operation stages of the gating units 141 include the first gating stage and the second gating stage. The details are as follows.

In the first gating stage, the gating control line MUX 13 provides the low level, then the first switching element K1a of the gating unit 141a is turned on and the second switching element K2a of the gating unit 141a is turned off, and the first switching element K1b of the gating unit 141b is turned on and the second switching element K2b of the gating unit 141b is turned off, so that the data signal of the data source line 130a is transmitted to the data signal line 110a, and the data signal of the data source line 130b is transmitted to the data signal line 110c.

In the second gating stage, the gating control line MUX 13 provides the high level, then the first switching element K1a of the gating unit 141a is turned off and the second switching element K2a of the gating unit 141a is turned on, and the first switching element K1b of the gating unit 141b is turned off and the second switching element K2b of the gating unit 141b is turned on, so that the data signal of the data source line 130a is transmitted to the data signal line 110b, and the data signal of the data source line 130b is transmitted to the data signal line 110d.

Optionally, when the display panel displays the first color image of the solid color, the first color sub-pixels 121 in the display panel are driven to emit light. Optionally, the low level is used for charging the first color sub-pixels 121, and the high level is used for charging the second color sub-pixels 122 and the third color sub-pixels 123. Referring to FIG. 3 and FIG. 5, when any row of sub-pixels 120 are charged, only the plurality of data signal lines 110 which are electrically connected to the first color sub-pixels 121 may be maintained to output the low level constantly to charge the first color sub-pixels 121 in the plurality of pixel rows without affecting the process for charging the sub-pixels of other colors. Accordingly, the frequent level conversion is not required for the plurality of data source lines 130 which are electrically connected to the first color sub-pixels 121, so that the loss which is caused by the level conversion in the data source lines in the solid color image may be reduced, achieving the low power consumption for the display panel.

In other embodiments, optionally, the multiplexer circuit may further have other structures, which is not limited to the above illustration.

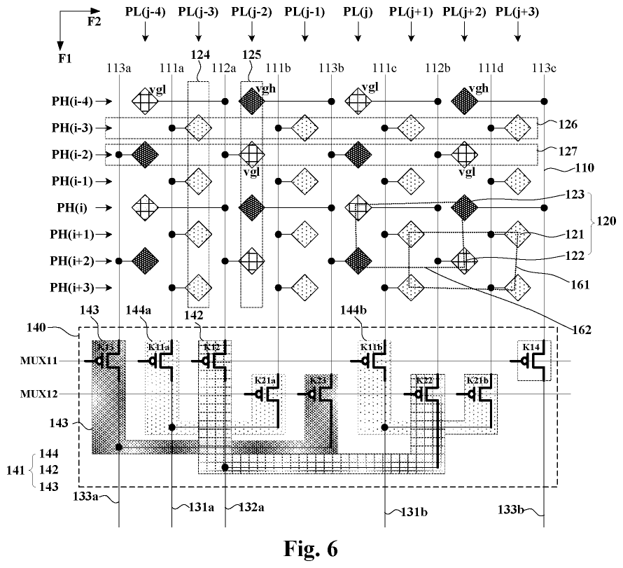

FIG. 6 is a schematic view of yet another display panel according to embodiments of the present application. As shown in FIG. 6, optionally, the display panel includes the first pixel row 126 and the second pixel row 127 which are alternately arranged along first direction F1 and the first pixel column 124 and the second pixel column 125 which are alternately arranged along second direction F2; the first pixel row 126 includes a plurality of first color sub-pixels 121 which are arranged along the second direction F2; the second pixel row 127 includes the second color sub-pixels 122 and the third color sub-pixels 123 which are alternately arranged along the second direction F2; the first pixel column 124 includes a plurality of first color sub-pixels 121 which are arranged along the first direction F1; and the second pixel column 125 includes the second color sub-pixels 122 and the third color sub-pixels 123 which are alternately arranged along the first direction F1.

In this embodiment, the plurality of first color sub-pixels 121 are arranged along the first direction F1 to form one first pixel column 124, and the plurality of first color sub-pixels 121 are arranged along the second direction F2 to form one first pixel row 126. The plurality of second color sub-pixels 122 and the plurality of third color sub-pixels 123 are alternately arranged along the first direction F1 to form one second pixel column 125, and the second pixel column 125 is the same as the second-type pixel column in FIG. 1. The plurality of second color sub-pixels 122 and the plurality of third color sub-pixels 123 are alternately arranged along the second direction F2 to form one second pixel row 127. In the display panel, along the first direction F1, a plurality of first pixel rows 126 and a plurality of second pixel rows 127 are alternately arranged. Along the second direction F2, a plurality of first pixel columns 124 and a plurality of second pixel columns 125 are alternately arranged.

Optionally, four of the first color sub-pixels 121 form the first virtual quadrilateral 161, the first color sub-pixels 121 are located at the vertexes of the first virtual quadrilateral 161, and the second color sub-pixel 122 or the third color sub-pixel 123 is located in the first virtual quadrilateral 161; two of the second color sub-pixels 122 and two of the third color sub-pixels 123 form the second virtual quadrilateral 162, the second color sub-pixels 122 are located at the first vertexes of the second virtual quadrilateral 162, the third color sub-pixels 123 are located at the second vertexes of the second virtual quadrilateral 162, the first vertexes and the second vertexes are alternated and spaced apart from each other, and the first color sub-pixel 121 is located in the second virtual quadrilateral 162. Optionally, the first color sub-pixels 121 are green light-emitting elements; the second color sub-pixels 122 and the third color sub-pixels 123 are red light-emitting elements and blue light-emitting elements, respectively, which is not limited thereto.

Specifically, in the display panel, two of the second color sub-pixels 122 and two of the third color sub-pixels 123 form the second virtual quadrangle 162, two of the second color sub-pixels 122 are located at the positions where two opposite vertexes of the second virtual quadrangle 162 are located, and two of the third color sub-pixels 123 are located at the positions where other two opposite vertexes of the second virtual quadrangle 162 are located; the geometric centers of the second color sub-pixels 122 may or may not coincide with the vertexes of the second virtual quadrangle 162, and the geometric centers of the third color sub-pixel 123 may or may not coincide with the vertexes of the second virtual quadrangle 162. The first color sub-pixel 121 is located in the second virtual quadrangle 162.

Four of the first color sub-pixels 121 form the first virtual quadrilateral 161, the second color sub-pixel 122 or the third color sub-pixel 123 are located in the first virtual quadrilateral 161, and the geometric centers of the first color sub-pixels 121 may or may not coincide with the vertexes of the first virtual quadrilateral 161. Based on this, the sub-pixels in the display panel are evenly distributed, and the display effect is desired, which is also beneficial for achieving the high resolution of the display panel. However, the pixel layout of the display panel in the present application is not limited thereto.

As shown in FIG. 6, optionally, the plurality of data signal lines 110 include the first data signal line 111, the second data signal line 112, and the third data signal line 113; the first data signal line 111 is provided correspondingly to the first pixel column 124 and is electrically connected to the first pixel column 124; in the second pixel column 125, the second color sub-pixels 122 are electrically connected to the second data signal line 112 and the third color sub-pixels 123 are electrically connected to the third data signal line 113.

In this embodiment, the display panel includes a plurality of first data signal lines 111, and FIG. 6 shows adjacent four of the first data signal lines 111 in the display panel which are labeled as 111a, 111b, 111c, and 111d, respectively; the first data signal lines 111 are provided correspondingly to the first data columns 124 and are electrically connected to the first data columns 124; and correspondingly, the first data signal lines 111 are electrically connected only to the plurality of the first color sub-pixels 121 of the same light-emitting color.

The display panel includes a plurality of second data signal lines 112, and FIG. 6 shows adjacent two of the second data signal lines 112 in the display panel which are labeled as 112a and 112b, respectively; the second data signal line 112 is provided correspondingly to one of the second data columns 125 and is electrically connected to the second color sub-pixels 122 in another one of the second data columns 125.

The display panel includes a plurality of third data signal lines 113, FIG. 6 shows adjacent three of the third data signal lines 113 in the display panel which are labeled as113a, 113b, and 113c, respectively; the third data signal line 113 is provided correspondingly to one of the second data columns 125 and is electrically connected to the third color sub-pixels 123 in another one of the second data columns 125.

As shown in FIG. 6, optionally, one data signal line 110 is provided correspondingly to one column of sub-pixels 120; the second data signal line 112 is electrically connected to a plurality of second color sub-pixels 122 of the corresponding one of the second pixel columns 125 and is further electrically connected to a plurality of second color sub-pixels 122 of another one of the second pixel columns 125 which is adjacent to the second data signal line 112; the third data signal line 113 is electrically connected to a plurality of third color sub-pixels 123 of the corresponding one of the second pixel columns 125 and is further electrically connected to a plurality of third color sub-pixels 123 of another one of the second pixel columns 125 which is adjacent to the third data signal line 113.

In this embodiment, optionally, the display panel includes at least the pixel column PL (j−4) to the pixel column PL (j+3), (j−4) is greater than or equal to 1, and the display panel includes a plurality of first pixel columns 124 and a plurality of second pixel columns 125. Optionally, the third data signal line 113a is electrically connected to at least a plurality of third color sub-pixels 123 in the corresponding second pixel column PL (j−4). The first data signal line 111a is electrically connected to a plurality of first color sub-pixels 121 in the corresponding first pixel column PL (j−3). The second data signal line 112a is electrically connected to a plurality of second color sub-pixels 122 in the corresponding second pixel column PL (j−2) and is further electrically connected to a plurality of second color sub-pixels 122 in the second pixel column PL (j−4) which is adjacent to the second data signal line 112a. The first data signal line 111b is electrically connected to a plurality of first color sub-pixels 121 in the corresponding first pixel column PL (j−1). The third data signal line 113b is electrically connected to a plurality of third color sub-pixels 123 in the corresponding second pixel column PL (j) and is further electrically connected to a plurality of third color sub-pixels 123 in the second pixel column PL (j−2) which is adjacent to the third data signal line 113b. The first data signal line 111c is electrically connected to a plurality of first color sub-pixels 121 in the corresponding first pixel column PL (j+1). The second data signal line 112b is electrically connected to a plurality of second color sub-pixels 122 in the corresponding second pixel column PL (j+2) and is further electrically connected to a plurality of second color sub-pixels 122 in the second pixel column PL (j) which is adjacent to the second data signal line 112b. The first data signal line 111d is electrically connected to a plurality of first color sub-pixels 121 in the corresponding first pixel column PL (j+3). j is an integer and greater than or equal to 1.

It may be understood that, if the second pixel column PL (j−4) is the 1st second pixel column of the display panel, optionally, the third data signal line 113a may be further electrically connected to the plurality of third color sub-pixels 123 in the 2nd second pixel column PL (j−2). If the second pixel column PL (j+2) is the last second pixel column of the display panel, optionally, the third data signal line 113c may be further electrically connected to the plurality of third color sub-pixels 123 in the 1st second pixel column PL (j).

As shown in FIG. 6, optionally, the plurality of gating units 141 include the first gating unit 144, the second gating unit 142, and the third gating unit 143; N output terminals of the first gating unit 144 are electrically connected to N first data signal lines 111, respectively; N output terminals of the second gating unit 142 are electrically connected to N second data signal lines 112, respectively; N output terminals of the third gating unit 143 are electrically connected to N third data signal lines 113, respectively. Accordingly, optionally, a plurality of data source lines 130 include the first data source line 131 which is electrically connected to the first gating unit 144, the second data source line 132 which is electrically connected to the second gating unit 142, and the third data source line 133 which is electrically connected to the third gating unit 143.

In this embodiment, the multiplexer circuit 140 includes a plurality of first gating units 144, a plurality of second gating units 142, and a plurality of third gating units 143. Optionally, N=2, and accordingly, the gating units 141 each include the first switching element K1 and the second switching element K2. It may be seen that the first gating units 144 each include the first switching element K11 and the second switching element K21, and FIG. 6 shows two of the first gating units 144 which are the first gating unit 144a and the first gating unit 144b, respectively. The second gating units 142 each include the first switching element K12 and the second switching element K22, and FIG. 6 shows one of the second gating units 142. The third gating units 143 each include the first switching element K13 and the second switching element K23, and FIG. 6 shows one of the third gating units 143.

The first gating unit 144a includes the first switching element K11a and the second switching element K21a, the input terminal of the first switching element K11a and the input terminal of the second switching element K21a are both electrically connected to the first data source line 131a, the control terminal of the first switching element K11a is electrically connected to the gating control line MUX 11, the output terminal of the first switching element K11a is electrically connected to the gating control line MUX 12, and the output terminal of the second switching element K21a is electrically connected to the first data signal line 111b.

The first gating unit 144b includes the first switching element K11b and the second switching element K21b, the input terminal of the first switching element K11b and the input terminal of the second switching element K21b are both electrically connected to the first data source line 131b, the control terminal of the first switching element K11b is electrically connected to the gating control line MUX 11, the output terminal of the first switching element K11b is electrically connected to the gating control line MUX 12, and the output terminal of the second switching element K21b is electrically connected to the first data signal line 111d.

The second gating unit 142 includes the first switching element K12 and the second switching element K22, the input terminal of the first switching element K12 and the input terminal of the second switching element K22 are both electrically connected to the second data source line 132a, the control terminal of the first switching element K12 is electrically connected to the gating control line MUX 11, the output terminal of the first switching element K12 is electrically connected to the second data signal line 112a, and the output terminal of the second switching element K22 is electrically connected to the second data signal line 112b.

The third gating unit 143 includes the first switching element K13 and the second switching element K23, the input terminal of the first switching element K13 and the input terminal of the second switching element K23 are both electrically connected to the third data source line 133a, the control terminal of the first switching element K13 is electrically connected to the gating control line MUX 11, the output terminal of the first switching element K13 is electrically connected to the third data signal line 113a, the control terminal of the second switching element K23 is electrically connected to the gating control line MUX 12, and the output terminal of the second switching element K23 is electrically connected to the third data signal line 113b.

In this embodiment, optionally, if the data signal line 113a to the data signal line 111d are one data line group, the display panel may include a plurality of data line groups, and each of the data line groups corresponds to four of the gating units 141 and four of the data source lines 130 which are shown in FIG. 6. In an example, the first one of the data line groups of the display panel includes the data signal line 113a to the data signal line 111d; correspondingly, the data signal line 113c is located in the second one of the data line groups, and the data source line 133b is electrically connected to the data signal line 113c in the second one of the data line groups by the switching element K14.

In this embodiment, optionally, the switching elements include the P-type transistors, which is not limited thereto.

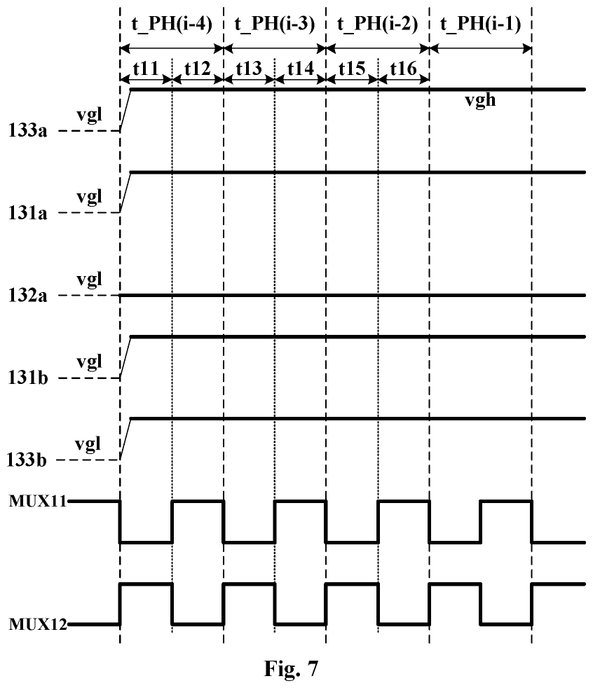

FIG. 7 is a time sequence diagram of the display panel shown in FIG. 6. Herein, only the example in which the display panel displays the second color image of the solid color is given for illustration. Optionally, when the display panel displays the second color image, the second color sub-pixels 122 in the display panel are driven to emit light. Optionally, the low level vgl is used for charging the second color sub-pixels 122, and the high level is used for charging the first color sub-pixels 121 and the third color sub-pixels 123.

Referring to FIG. 6 and FIG. 7, at least one of the data line groups (113a-111d) will be described to illustrate the operation process for the display panel to display the second color image. The details are as follows.

In the stage t_PH (i−4), a plurality of the second color sub-pixels 122 and a plurality of the third color sub-pixels 123 in the pixel row PH (i−4) are turned on; in the stage t11, the gating control line MUX 11 provides the low level, and the gating control line MUX 12 provides the high level, then the switching element K13, the switching element K11a, the switching element K12, the switching element K11b, and the switching element K14 are all turned on, the low level vgl which is provided by the second data source line 132a is transmitted to the second data signal line 112a, and the high level vgh which is provided by the third data source line 133b is transmitted to the third data signal line 113c; sequentially, in the stage t12, the gating control line MUX 11 provides the high level, and the gating control line MUX 12 provides the low level, then the switching element K21a, the switching element K23, the switching element K22, and the switching element K21b are all turned on, the high level vgh which is provided by the third data source line 133a is transmitted to the third data signal line 113b, and the low level vgl which is provided by the second data source line 132a is transmitted to the second data signal line 112b; therefore, in the pixel row PH (i−4), the low level vgl is used for charging the plurality of the second color sub-pixels 122, and the high level vgh is written to the plurality of the third-color sub-pixels 123.

Sequentially, in the stage t_PH (i−3), a plurality of the first color sub-pixels 121 in the pixel row PH (i−3) are turned on; in the stage t13, the gating control line MUX 11 provides the low level, then the high level vgh which is provided by the first data source line 131a is transmitted to the first data signal line 111a by the switching element K11a which is turned on, and the high level vgh which is provided by the first data source line 131b is transmitted to the first data signal line 111c by the switching element K11b which is turned on; in the stage t14, the gating control line MUX 12 provides the low level, then the high level vgh which is provided by the first data source line 131a is transmitted to the first data signal line 111b by the switching element K21a which is turned on, and the high level vgh which is provided by the first data source line 131b is transmitted to the first data signal line 111d by the switching element K21b which is turned on; therefore, in the pixel row PH (i−3), the high level vgh is written to the plurality of the first color sub-pixels 121.

Sequentially, in the stage t_PH (i−2), a plurality of the second color sub-pixels 122 and a plurality of the third color sub-pixels 123 in the pixel row PH (i−2) are turned on; in the stage t15, the gating control line MUX 11 provides the low level, then the high level vgh which is provided by the third data source line 133a is transmitted to the third data signal line 113a by the switching element K13 which is turned on, and the low level vgl which is provided by the second data source line 132a is transmitted to the second data signal line 112a by the switching element K12 which is turned on; in the stage t16, the gating control line MUX 12 provides the low level, then the high level vgh which is provided by the third data source line 133a is transmitted to the third data signal line 113b by the switching element K23 which is turned on, and the low level vgl which is provided by the second data source line 132a is transmitted to the second data signal line 112b by the switching element K22 which is turned on; therefore, in the pixel row PH (i−2), the low level vgl is used for charging the plurality of the second color sub-pixels 122, and the high level vgh is written to the plurality of the third color sub-pixels 123.

Sequentially, in the stage t_PH (i−1), the high level vgh which is provided by the first data source line 131a and the first data source line 131b is written to the plurality of the first color sub-pixels 121 in the pixel row PH (i−1).

Similarly, the high level vgh of the first data source line 131 is written to the plurality of the first color sub-pixels 121, the low level vgl of the second data source line 132 is written to the plurality of the second color sub-pixels 122, and the high level vgh of the third data source line 133 is written to the plurality of the third color sub-pixels 123.

Obviously, when the second color image is displayed, the first data source line 131 may be maintained to out the high level vgh, the second data source line 132 may be maintained to output the low level vgl, and the third data source line 133 may be maintained to output the high level vgh.

Similarly, when the first color image is displayed, referring to FIG. 3, the first data source line 131 may be maintained output the low level vgl, the plurality of data source lines which are electrically connected to the second color sub-pixels may be maintained to output the high level, and the plurality of data source lines which are electrically connected to the third color sub-pixels may be maintained to output the high level.

Therefore, when the display panel displays the solid color image, the frequent level conversion is not required for the plurality of data source lines 130, so that the loss which is caused by the level conversion in the data source lines in the solid color image may be reduced, achieving the low power consumption for the display panel.

It should be noted that, in the display panel, the time lengths for charging the sub-pixels of the same color which are located in different two of the pixel columns may be the same or different one another. In an example, under a condition that the refresh frequency of the display panel is 120 Hz, the time length of t11 may be 0.8/H, the time length of t12 may be 1.4/H, and H may be the time length for turning on one row of sub-pixels; optionally, the terminating moment of t11 is earlier than the starting moment of t12, for example, the interval between t11 and t12 may be 0.2/H; and optionally, the terminating moment of t12 is earlier than the starting moment of t13, for example, the interval between the t12 and t13 may be 0.5/H. Herein, the unit of the time length may be microseconds (μs). The time parameter such as the time length for charging two different pixel columns and the interval described herein is merely an example and a reference, and those skilled in the art may properly set the time parameter such as the time length for charging two different pixel columns and the interval between the charging stage and the discharging stages which are adjacent to each other based on the requirements for the product, which is not repeated or explained.

FIG. 8 is a schematic view of yet another display panel according to embodiments of the present application. As shown in FIG. 8, optionally, the display panel includes the first pixel row 126 and the second pixel row 127 which are alternately arranged along the first direction F1 and the first pixel column 124 and the second pixel column 125 which are alternately arranged along the second direction F2; the first pixel row 126 includes a plurality of first color sub-pixels 121 which are arranged along the second direction F2; the second pixel row 127 includes the second color sub-pixels 122 and the third color sub-pixels 123 which are alternately arranged along the second direction F2; the first pixel column 124 includes a plurality of first color sub-pixels 121 which are arranged along the first direction F1; and the second pixel column 125 includes the second color sub-pixels 122 and the third color sub-pixels 123 which are alternately arranged along the first direction F1.

Optionally, the plurality of data signal lines 110 include the first data signal line 111 and the second data signal line 114; one data signal line 110 is provided correspondingly to one column of sub-pixels 120; the first data signal line 111 is provided correspondingly to the first pixel column 124 and is electrically connected to the first pixel column 124; and the second data signal line 114 is provided correspondingly to the second pixel column 125 and is electrically connected to the second pixel column 125. Optionally, the plurality of gating units 141 include the first gating unit 144 and the second gating unit 145; N output terminals of the first gating unit 144 are electrically connected to N first data signal lines 111, respectively; and N output terminals of the second gating unit 145 are electrically connected to N second data signal lines 114, respectively. In this embodiment, optionally, N=2.

As shown in FIG. 8, the display panel includes four adjacent first data signal lines 111 which are labeled as 111a, 111b, 111c, and 111d, respectively, the plurality of gating units 141 includes a plurality of first gating units 144, and the connection relationship of the first gating units 144 is the same as that in FIG. 6, which is not repeated herein.

FIG. 8 is different from FIG. 6 in that the display panel in FIG. 8 includes four adjacent second data signal lines 114, which are labeled as 114a, 114b, 114c, and 114d, respectively, and one second data signal line 114 corresponds to one second data column 125 and is electrically connected to the one second data column 125. The plurality of gating units 141 include a plurality of second gating units 145, and only the second gating unit 145a and the second gating unit 145b are shown herein. Optionally, the plurality of data source lines 130 include the first data source line 131 which is electrically connected to the first gating units 144 and the second data source line 134 which is electrically connected to the second gating units 145. The second gating units 145 each include the first switching element K15 and the second switching element K25.

The second gating unit 145a includes the first switching element K15a and the second switching element K25a; the input terminal of the first switching element K15a and the input terminal of the second switching element K25a are both electrically connected to the second data source line 134a; the control terminal of the first switching element K15a is electrically connected to the gating control line MUX 11, and the output terminal of the first switching element K15a is electrically connected to the second data signal line 114a; the control terminal of the second switching element K25a is electrically connected to the gating control line MUX 12, and the output terminal of the second switching element K25a is electrically connected to the second data signal line 114b.

The second gating unit 145b includes the first switching element K15b and the second switching element K25b; the input terminal of the first switching element K15b and the input terminal of the second switching element K25b are electrically connected to the second data source line 134b; the control terminal of the first switching element K15b is electrically connected to the gating control line MUX 11, and the output terminal of the first switching element K15b is electrically connected to the second data signal line 114c; the control terminal of the second switching element K25b is electrically connected to the gating control line MUX 12, and the output terminal of the second switching element K25b is electrically connected to the second data signal line 114d.

In this embodiment, optionally, the switching elements include the P-type transistors, which is not limited thereto.

FIG. 9 is a time sequence diagram of the display panel shown in FIG. 8. Herein, only the example in which the display panel displays the third color image of the solid color is given for illustration. Optionally, when the display panel displays the third color image, the third color sub-pixels 123 in the display panel are driven to emit light. Optionally, the low level vgl is used for charging the third color sub-pixels 123, and the high level is used for charging the first color sub-pixels 121 and the second color sub-pixels 122. Referring to FIG. 8 and FIG. 9, the operation process for the display panel to display the third color image is as follows.

In the stage t_PH (i−4), the pixel row PH (i−4) is turned on; in the stage t21, the gating control line MUX 11 provides the low level, the second data source line 134a provides the high level vgh, and the high level vgh which is provided by the second data source line 134a is transmitted to the second data signal line 114a by the switching element K15a which is turned on, the second data source line 134b provides the high level vgh, and the high level vgh which is provided by the second data source line 134b is transmitted to the second data signal line 114c by the switching element K15b which is turned on; in the stage t22, the gating control line MUX 12 provides the low level, the second data source line 134a provides the low level vgl, and the low level vgl which is provided by the second data source line 134a is transmitted to the second data signal line 114b by the switching element K25a which is turned on, the second data source line 134b provides the low level vgl, and the low level vgl which is provided by the second data source line 134b is transmitted to the second data signal line 114d by the switching element K25b which is turned on; then, in the pixel row PH (i−4), the low level vgl is used for charging the plurality of third color sub-pixels 123, and the high level vgh is written to the plurality of second color sub-pixels 122.

Sequentially, in the stage t_PH (i−3), the pixel row PH (i−3) is turned on; in the stage t23, the gating control line MUX 11 provides the low level, the first data source line 131a provides the high level vgh, and the high level vgh which is provided by the first data source line 131a is transmitted to the first data signal line 111a by the switching element K11a which is turned on, the first data source line 131b provides the high level vgh, and the high level vgh which is provided by the first data source line 131b is transmitted to the first data signal line 111c by the switching element K11b which is turned on; in the stage t24, the gating control line MUX 12 provides the low level, the first data source line 131a provides the high level vgh, and the high level vgh which is provided by the first data source line 131a is transmitted to the first data signal line 111b by the switching element K21a which is turned on, the first data source line 131b provides the high level vgh, and the high level vgh which is provided by the first data source line 131b is transmitted to the first data signal line 111d by the switching element K21b which is turned on; then in the pixel row PH (i−3), the high level vgh is written to the plurality of first color sub-pixels 121.

Sequentially, in the stage t_PH (i−2), the pixel row PH (i−2) is turned on; in the stage t25, the gating control line MUX 11 provides the low level, the second data source line 134a provides the low level vgl, and the low level vgl which is provided by the second data source line 134a is transmitted to the second data signal line 114a by the switching element K15a which is turned on, the second data source line 134b provides the low level vgl, and the low level vgl which is provided by the second data source line 134b is transmitted to the second data signal line 114c by the switching element K15b which is turned on; in the stage t26, the gating control line MUX 12 provides the low level, the second data source line 134a provides the high level vgh, and the high level vgh which is provided by the second data source line 134a is transmitted to the second data signal line 114b by the switching element K25a which is turned on, the second data source line 134b provides the high level vgh, and the high level vgh which is provided by the second data source line 134b is transmitted to the second data signal line 114d by the switching element K25b which is turned on; then, in the pixel row PH (i−2), the low level vgl is used for charging the plurality of third color sub-pixels 123, and the high level vgh is written to the plurality of second color sub-pixels 122.

Sequentially, in the stage t_PH (i−1), the high level vgh which is provided by the first data source line 131a and the first data source line 131b is written to the plurality of first color sub-pixels 121 in the pixel row PH (i−1), and so on.

Obviously, when the third color image is displayed, the first data source line 131 may be maintained to output the high level vgh, and the second data source line 132 may undergo a high-low level jump. Therefore, when the display panel displays the solid color image, the frequent level conversion is not required for the plurality of data source lines 130, so that the loss which is caused by the level conversion in the data source lines in the solid color image may be reduced, achieving the low power consumption for the display panel.

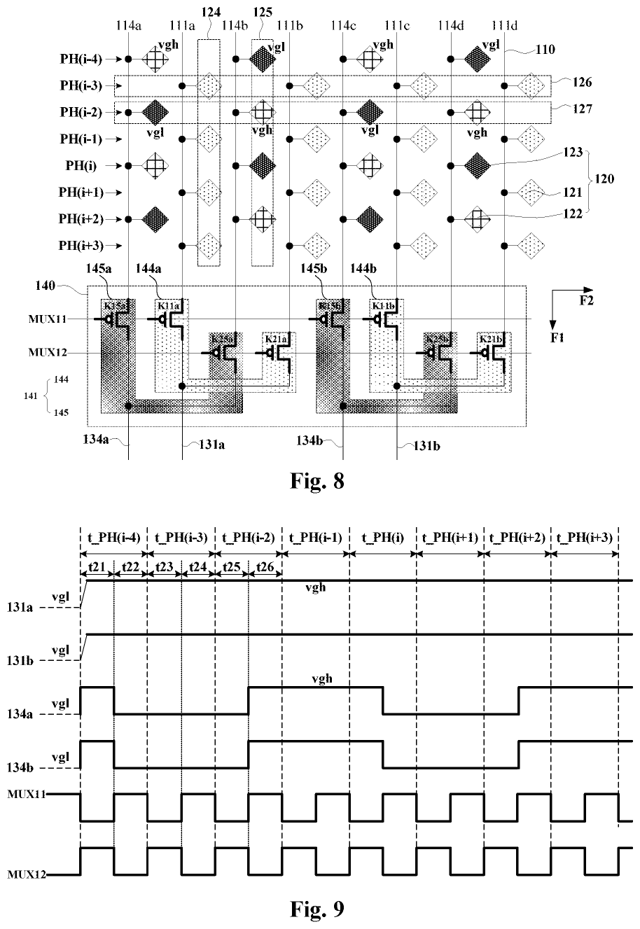

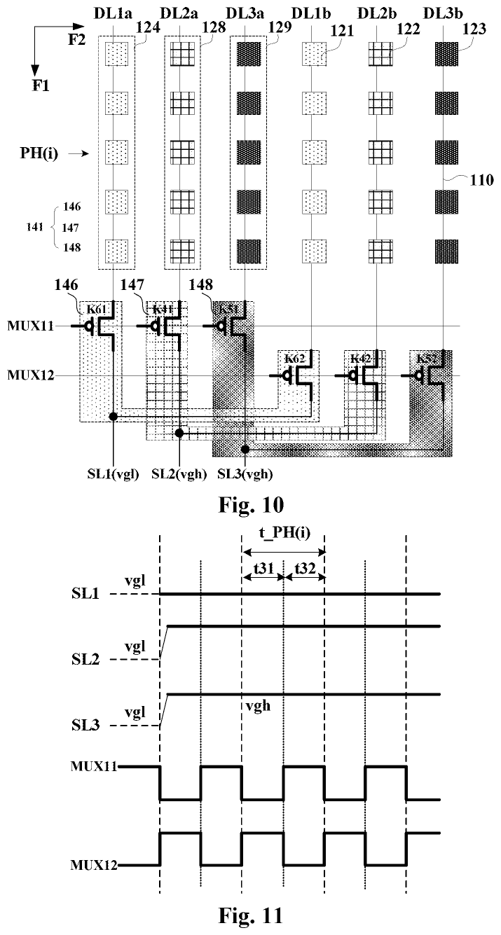

FIG. 10 is a schematic view of yet another display panel according to embodiments of the present application. As shown in FIG. 10, optionally, the display panel includes the first pixel column 124, the second pixel column 128, and the third pixel column 129 which are alternately arranged along second direction F2; the first pixel column 124 includes a plurality of first color sub-pixels 121 which are arranged along the first direction F1; the second pixel column 128 includes a plurality of second color sub-pixels 122 which are arranged along the first direction F1; and the third pixel column 129 includes a plurality of third color sub-pixels 123 which are arranged along the first direction F1. Optionally, the plurality of data signal lines 110 include the first data signal line DL1, the second data signal line DL2, and the third data signal line DL3; one data signal line 110 is provided correspondingly to one column of sub-pixels 120 and is electrically connected to the one column of sub-pixels 120; the first data signal line DL1 is provided correspondingly to the first pixel column 124 and is electrically connected to the first pixel column 124; the second data signal line DL2 is provided correspondingly to the second pixel column 128 and is electrically connected to the second pixel column 128; and the third data signal line DL3 is provided correspondingly to the third pixel column 129 and electrically connected to the third pixel column 129. Optionally, the plurality of gating units 141 include the first gating unit 146, the second gating unit 147, and the third gating unit 148; N output terminals of the first gating unit 146 are electrically connected to N first data signal lines DL1, respectively; N output terminals of the second gating unit 147 are electrically connected to N second data signal lines DL2, respectively; and N output terminals of the third gating unit 148 are electrically connected to N third data signal lines DL3, respectively. In this embodiment, optionally, N=2.

As shown in FIG. 10, the first gating unit 146 includes the switching element K61 and the switching element K62; the input terminal of the switching element K61 and the input terminal of the switching element K62 are both electrically connected to the data source line SL1, the control terminal of the switching element K61 is electrically connected to the gating control line MUX 11, the output terminal of the switching element K61 is electrically connected to the first data signal line DL1a, the control terminal of the switching element K62 is electrically connected to the gating control line MUX 12, and the output terminal of the switching element K62 is electrically connected to the first data signal line DL1b.

The second gating unit 147 includes the switching element K41 and the switching element K42; the input terminal of the switching element K41 and the input terminal of the switching element K42 are both electrically connected to the data source line SL2, the control terminal of the switching element K41 is electrically connected to the gating control line MUX 11, the output terminal of the switching element K41 is electrically connected to the second data signal line DL2a, the control terminal of the switching element K42 is electrically connected to the gating control line MUX 12, and the output terminal of the switching element K42 is electrically connected to the second data signal line DL2b.

The third gating unit 148 includes the switching element K51 and the switching element K52; the input terminal of the switching element K51 and the input terminal of the switching element K52 are both electrically connected to the data source line SL3, the control terminal of the switching element K51 is electrically connected to the gating control line MUX 11, the output terminal of the switching element K51 is electrically connected to the third data signal line DL3a, the control terminal of the switching element K52 is electrically connected to the gating control line MUX 12, and the output terminal of the switching element K52 is electrically connected to the third data signal line DL3b.

In this embodiment, optionally, the switching elements include the P-type transistors, which is not limited thereto.

FIG. 11 is a time sequence diagram of the display panel shown in FIG. 10. Herein, only the example in which the display panel displays the first color image of the solid color is given for illustration. Optionally, when the display panel displays the first color image, the first color sub-pixels 121 in the display panel are driven to emit light. Optionally, the low level vgl is used for charging the first color sub-pixels 121, and the high level is used for charging the third color sub-pixels 123 and the second color sub-pixels 122. Referring to FIG. 10 and FIG. 11, the operation process for the display panel to display the first color image is as follows.

In the stage t_PH (i), the pixel row PH (i) is turned on; in the stage t31, the gating control line MUX 11 provides the low level, the first data source line SL1 provides the low level vgl, and the low level vgl which is provided by the first data source line SL1 is transmitted to the first data signal line DL1a by the switching element K61 which is turned on, the second data source line SL2 provides the high level vgh, and the high level vgh which is provided by the second data source line SL2 is transmitted to the second data signal line DL2a by the switching element K41 which is turned on, the third data source line SL3 provides the high level vgh, and the high level vgh which is provided by the third data source line SL3 is transmitted to the third data signal line DL3a by the switching element K51 which is turned on; in the stage t32, the gating control line MUX 12 provides the low level, the first data source line SL1 provides the low level vgl, and the low level vgl which is provided by the first data source line SL1 is transmitted to the first data signal line DL1b by the switching element K62 which is turned on, the second data source line SL2 provides the high level vgh, and the high level vgh which is provided by the second data source line SL2 is transmitted to the second data signal line DL2b by the switching element K42 which is turned on, the third data source line SL3 provides the high level vgh, and the high level vgh which is provided by the third data source line SL3 is transmitted to the third data signal line DL3b by the switching element K52 which is turned on; then, in the pixel row PH (i), the low level vgl is used for charging the plurality of first-color sub-pixels 121, and the high level vgh is written to the plurality of second-color sub-pixels 122 and the plurality of third-color sub-pixels 123, and so on. Obviously, when the first color image is displayed, the first data source line SL1 may be maintained to output the low level vgl, and the second data source line SL2 and the third data source line SL3 may be both maintained to output the high level vgh. Therefore, when the display panel displays the solid color image, the frequent level conversion is not required for the plurality of data source lines, so that the loss which is caused by the level conversion in the data source lines in the solid color image may be reduced, achieving the low power consumption for the display panel.

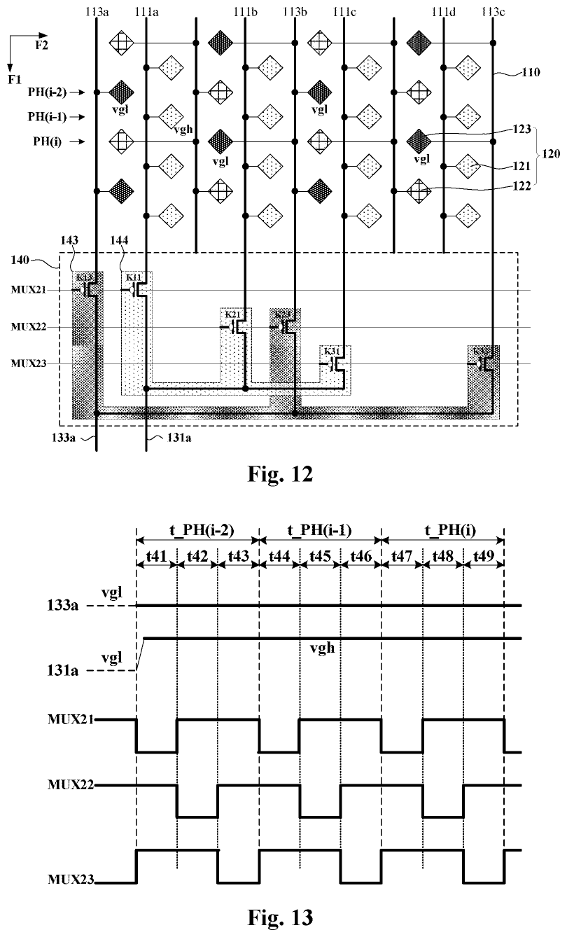

FIG. 12 is a schematic view of yet another display panel according to embodiments of the present application, and there is the difference between the the display panel shown in FIG. 12 and the display panel shown in FIG. 6. Specifically, in the display panel shown in FIG. 12, N=3, then the first data source line 131a is electrically connected to three first data signal lines 111 by the first gating unit 144, and the three first data signal lines 111 are the first data signal line 111a, the first data signal line 111b and the first data signal line 111c, respectively. The third data source line 133a is electrically connected to three third data signal lines 113 by the third gating unit 143, and the three third data signal lines 113 are the third data signal line 113a, the third data signal line 113b and the third data signal line 113c, respectively. The electrical connection of the second data source line is similar to the electrical connection of the second data signal line, which is not repeated herein.

Accordingly, the first gating unit 144 includes the first switching element K11, the second switching element K21, and the third switching element K31. The third gating unit 143 includes the first switching element K13, the second switching element K23, and the third switching element K33. Reference is made to the drawing for the electrical connection of the switching elements, which is not repeated herein.

The multiplexer circuit 140 may include three gating control lines which are the gating control line MUX 21, the gating control line MUX 22, and the gating control line MUX 23, respectively. The gating control line MUX 21 is electrically connected to the control terminal of the first switching element K11 in the first gating unit 144 and the control terminal of the first switching element K13 in the third gating unit 143. The gating control line MUX 22 is electrically connected to the control terminal of the second switching element K21 in the first gating unit 144 and the control terminal of the second switching element K23 in the third gating unit 143. The gating control line MUX 23 is electrically connected to the control terminal of the third switching element K31 in the first gating unit 144 and the control terminal of the third switching element K33 in the third gating unit 143. In this embodiment, optionally, the switching elements include the P-type transistors, which is not limited thereto.

FIG. 13 is a time sequence diagram of the display panel shown in FIG. 12. Herein, only the example in which the display panel displays the third color image of the solid color is given for illustration. Optionally, when the display panel displays the third color image, the third color sub-pixels 123 in the display panel are driven to emit light. Optionally, the low level vgl is used for charging the third color sub-pixels 123, and the high level is used for charging the first color sub-pixels 121 and the second color sub-pixels 122.

Referring to FIG. 12 and FIG. 13, the operation process for the display panel to display the third color image is as follows.

In the stage t_PH (i−2), the pixel row PH (i−2) is turned on; in the stage t41, the gating control line MUX 21 provides the low level, and the low level vgl which is provided by the third data source line 133a is transmitted to the third data signal line 113a by the switching element K13 which is turned on; sequentially, in the stage t42, the gating control line MUX 22 provides the low level, and the low level vgl which is provided by the third data source line 133a is transmitted to the third data signal line 113b by the switching element K23 which is turned on; sequentially, in the stage t43, the gating control line MUX 23 provides the low level, and the low level vgl which is provided by the third data source line 133a is transmitted to the third data signal line 113c by the switching element K33 which is turned on; then in the pixel row PH (i−2), the low level vgl is used for charging the plurality of third-color sub-pixels 123, and it should be noted that in the stage t41 to the stage t43, the second data source line provides the high level, and the high level is written to the plurality of second-color sub-pixels 122 in this row.

In the stage t_PH (i−1), the pixel row PH (i−1) is turned on; in the stage t44, the gating control line MUX 21 provides the low level, and the high level vgh which is provided by the first data source line 131a is transmitted to the first data signal line 111a by the switching element K11 which is turned on; sequentially, in the stage t45, the gating control line MUX 22 provides the low level, and the high level vgh which is provided by the first data source line 131a is transmitted to the first data signal line 111b by the switching element K21 which is turned on; sequentially, in the stage t46, the gating control line MUX 23 provides the low level, and the high level vgh which is provided by the first data source line 131a is transmitted to the first data signal line 111c by the switching element K31 which is turned on; then in the pixel row PH (i−1), the high level vgh is written to the plurality of first color sub-pixels 121.

In the stage t_PH (i), the pixel row PH (i) is turned on; in the stage t47, the gating control line MUX 21 provides the low level, and the low level vgl which is provided by the third data source line 133a is transmitted to the third data signal line 113a by the switching element K13 which is turned on; sequentially, in the stage t48, the gating control line MUX 22 provides the low level, and the low level vgl which is provided by the third data source line 133a is transmitted to the third data signal line 113b by the switching element K 23 which is turned on; sequentially, in the stage t49, the gating control line MUX 23 provides the low level, and the low level vgl which is provided by the third data source line 133a is transmitted to the third data signal line 113c by the switching element K33 which is turned on; then, in the pixel row PH (i), the low level vgl is used for charging the plurality of third color sub-pixels 123, in the stage t47 to the stage t49, the second data source line provides the high level, and the high level is written to the plurality of second color sub-pixels 122 in this row.

Similarly, the high level vgh of the first data source line 131 is written to the plurality of first color sub-pixels 121, the high level vgh of the second data source line is written to the plurality of second color sub-pixels 122, and the low level vgl of the third data source line 133 is written to the plurality of third color sub-pixels 123.

Obviously, when the third color image is displayed, the first data source line 131 may be maintained to output the high level vgh, the second data source line may be maintained to output the high level vgh, and the third data source line 133 may be maintained to output the low level vgl.

Therefore, when the display panel displays the solid color image, the frequent level conversion is not required for the plurality of data source lines 130, so that the loss which is caused by the level conversion in the data source lines in the solid color image may be reduced, achieving the low power consumption for the display panel.

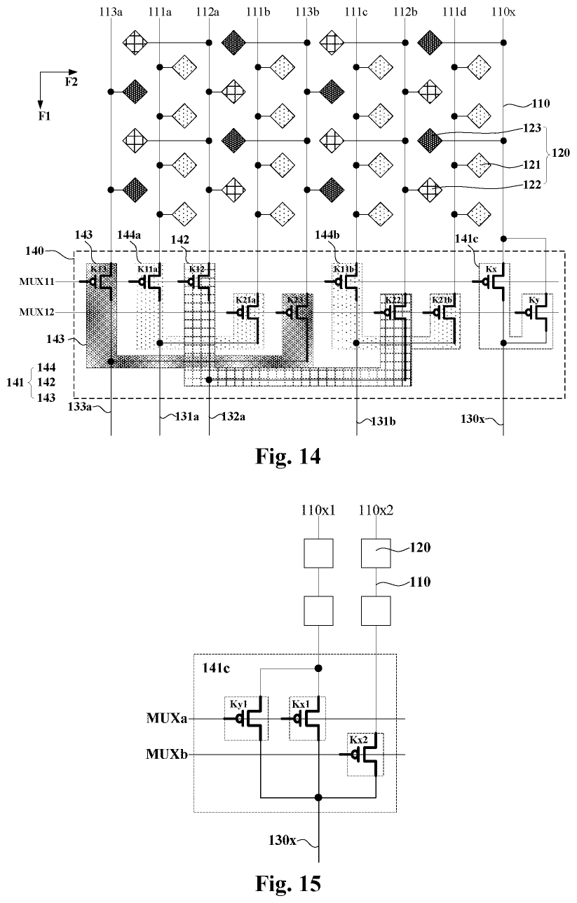

FIG. 14 is a schematic view of yet another display panel according to embodiments of the present application. As shown in FIG. 14, optionally, the multiplexer circuit 140 includes the redundant gating unit 141c which is electrically connected to Na data signal lines 110, and Na<N; the redundant gating unit 141c includes Na first-type switching elements Kx, and the output terminals of Na first-type switching elements Kx are electrically connected to Na data signal lines 110, respectively. Optionally, the redundant gating unit 141c further includes Nb compensation switching elements Ky, Nb≤Na, Na+Nb≤N; the output terminals of Nb compensation switching elements Ky are electrically connected to Nb of Na data signal lines 110, respectively. Optionally, the first-type switching element Kx and the compensation switching element Ky which are connected to the same data signal line 110 are turned on in a time-sharing manner. In this embodiment, optionally, N=2, and Nb=Na=1.

Based on the difference in the pixel layouts in the display panel, the number of the data signal lines 110 which are electrically connected to one or more data source lines 130x may be less than the number of the data signal lines 110 which are electrically connected to other data source lines 130.

Referring to FIG. 14, the data source line 133a correspondingly drives two data signal lines 110 which are the data signal line 113a and the data signal line 113b, respectively. The data source line 131a correspondingly drives two data signal lines 110, the data source line 132a correspondingly drives two data signal lines 110, and the data source line 131b correspondingly drives two data signal lines 110. The data source line 130x correspondingly drives only one data signal line 110x.

If the compensation switching elements Ky are not provided, in the display panel the number of the switching elements which are electrically connected to the data source line 130x is less than the number of the switching elements which are electrically connected to other data source lines 130, so that the driving load or column impedance of the data source line 130x is different from the driving load or column impedance of other data source lines 130.

In this embodiment, the data source line 130x is electrically connected to the redundant gating unit 141c, the redundant gating unit gating unit 141c is electrically connected to one data signal line 110x and includes one first-type switching element Kx, and the output terminal of the first-type switching element Kx is electrically connected to the data signal line 110x. In order to balance the data source line 130x against other data source lines 130, that is, to bring the driving load or column impedance of the data source line 130x close to the driving load or column impedance of other data source lines 130, one compensation switching element Ky is provided in the redundant gating unit 141c.

In the redundant gating unit 141c, the input terminal of the first-type switching element Kx and the input terminal of the compensation switching element Ky are both electrically connected to the data source line 130x, the control terminal of the first-type switching element Kx is electrically connected to the gating control line MUX 11, the control terminal of the compensation switching element Ky is electrically connected to the gating control line MUX 12, and the output terminal of the first-type switching element Kx and the output terminal of the compensation switching element Ky are both electrically connected to the same data signal line 110x. Therefore, the redundant gating unit 141c includes two switching elements, the number of the switching elements in the redundant gating unit 141c is equal to the number of the switching elements in other gating units 141, and two switching elements in the redundant gating unit 141c are turned on in a time-sharing manner. Accordingly, the difference between the data source line 130x and other data source lines 130 may be reduced, and the driving load or column impedance of the data source line 130x may be close to the driving load or column impedance of other data source lines 130.

If the number of the data signal lines which are correspondingly driven by other data source lines in the display panel is three or more, the number of the compensation switching elements in the redundant gating unit may be one or more. Herein, the example in which the number of the data signal lines which are correspondingly driven by other data source lines in the display panel is three and the number of the data signal lines 110 which are correspondingly driven by the data source line 130x is two is given for illustration.

FIG. 15 is a schematic view of a redundant gating unit according to embodiments of the present application. As shown in FIG. 15, the redundant gating unit 141c includes two first-type switching elements Kx which are the first-type switching element Kx1 and the first-type switching element Kx2, respectively. The redundant gating unit 141c further includes one compensation switching element Ky1. Optionally, the input terminal of the first-type switching element Kx1, the input terminal of the first-type switching element Kx2, and the input terminal of the compensation switching element Ky1 are all electrically connected to the data source line 130x, the output terminal of the first-type switching element Kx1 and the output terminal of the compensation switching element Ky1 are both electrically connected to the data signal line 110x1, and the output terminal of the first-type switching element Kx2 is electrically connected to the data signal line 110x2. If the multiplexer circuit includes two gating control lines MUXa and MUXb, the gating control line MUXa is electrically connected to the control terminal of the first-type switching element Kx1 and the control terminal of the compensation switching element Ky1, and the gating control line MUXb is electrically connected to the control terminal of the first-type switching element Kx2. Of course, if the multiplexer circuit includes three or more gating control lines, the connection of the control terminals of the plurality of switching elements in the gating unit is properly adjusted.

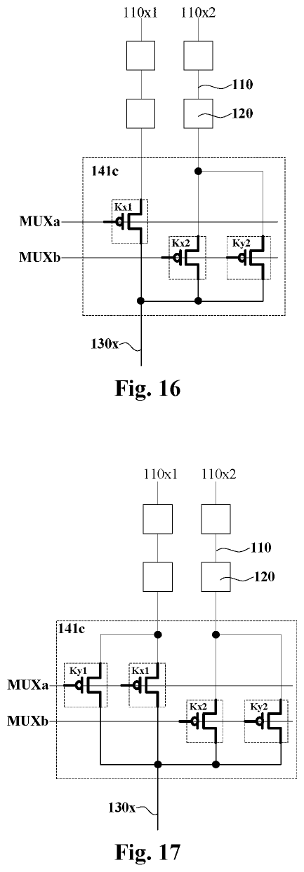

FIG. 16 is a schematic view of another redundant gating unit according to embodiments of the present application, and there is a difference between FIG. 16 and FIG. 15. Specifically, in FIG. 16, the output terminal of the compensation switching element Ky2 of the redundant gating unit 141c and the output terminal of the first-type switching element Kx2 are both electrically connected to the data signal line 110x2. If the multiplexer circuit includes two gating control lines MUXa and MUXb, the gating control line MUXa is electrically connected to the control terminal of the first-type switching element Kx1, and the gating control line MUXb is electrically connected to the control terminal of the first-type switching element Kx2 and the control terminal of the compensation switching element Ky2. Of course, if the multiplexer circuit includes three or more gating control lines, the connection of the control terminals of the plurality of switching elements in the gating unit is properly adjusted.

Herein, the example in which the number of the data signal lines which are correspondingly driven by other data source lines in the display panel is four and the number of the data signal lines 110 which are correspondingly driven by the data source line 130x is two is given for illustration. FIG. 17 is a schematic view of yet another redundant gating unit according to embodiments of the present application. As shown in FIG. 17, the redundant gating unit 141c includes two first-type switching elements Kx which are the first-type switching element Kx1 and the first-type switching element Kx2, respectively; and the redundant gating unit 141c further includes two compensation switching elements Ky which are the compensation switching element Ky1 and the compensation switching element Ky2, respectively. If the multiplexer circuit includes two gating control lines MUXa and MUXb, reference is made to FIG. 15 for the electrical connection of the compensation switching element Ky1, and reference is made to FIG. 16 for the electrical connection of the compensation switching element Ky2. Of course, if the multiplexer circuit includes three or more gating control lines, the connection of the control terminals of the plurality of switching elements in the gating unit is properly adjusted, which is not repeated herein.

In this embodiment, by providing the compensation switching elements, the driving loads or column impedances of two different data source lines in the display panel may be close to each other, which is beneficial for increasing the charging effect.

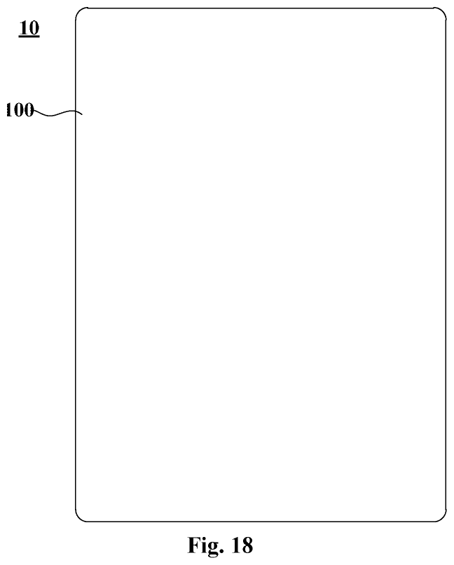

Based on the same inventive concept, embodiments of the present application further provide a display apparatus which includes any one of the display panels according to the above embodiments. FIG. 18 is a schematic view of a display apparatus according to embodiments of the present application, and the display apparatus 10 includes the display panel 100. Therefore, the display apparatus 10 also has the beneficial effects of the display panel 100 in the above embodiments, and the similarities may be understood with reference to the above explanation of the display panel 100, which is not repeated hereinafter.

The display apparatus 10 according to the embodiments of the present application may be the mobile phone shown in FIG. 18, or any electronic product which has the display function, including, but not limited to, the following categories: televisions, notebook computers, desktop displays, tablet computers, digital cameras, smart bracelets, smart glasses, vehicle-mounted displays, industrial control equipment, medical display screens, touch interactive terminals, and the like, which is not particularly limited by the embodiments of the present application.

In the display apparatus 10 according to the embodiments of the present application, the display panel 100 may include but be not limited to these categories such as organic light-emitting display panels, liquid crystal display panels, or micro light-emitting diode display panels, and the light-emitting type of the display panel 100 is not particularly limited by the embodiments of the present application.

It should be understood that the steps may be reordered, added, or deleted using the various forms of flows shown above. For example, the steps described in the present application may be executed in parallel, in sequence, or in different orders as long as the desired results of the technical solutions of the present application can be achieved, which is not limited herein.

The above specific embodiments do not limit the protection scope of the present application. It may be understood by those skilled in the art that various modifications, combinations, sub-combinations, and substitutions may be made depending on design requirements and other factors. Any modification, equivalent substitution and improvement made within the spirit and principle of the present application should be included in the protection scope of the present application.

What is claimed is:

1. A display panel comprising:
a plurality of data signal lines and a plurality of sub-pixels, the plurality of data signal lines extending along a first direction and being arranged along a second direction intersecting with the second direction, and the data signal lines being electrically connected to the plurality of sub-pixels;
a plurality of data source lines extending along the first direction and arranged along the second direction;
a multiplexer circuit comprising a plurality of gating units which each comprise one input terminal and N output terminals, the input terminals of the gating units being electrically connected to the data source lines, and the N output terminals of each of the gating units being electrically connected to N of the data signal lines, respectively, where N≥2; and
at least one of the gating units satisfying a case that the N of the data signal lines are electrically connected to a plurality of the sub-pixels of a same color.

2. The display panel according to claim 1, wherein the multiplexer circuit comprises a plurality of gating control lines;
the gating units each comprise N switching elements, input terminals of the switching elements being electrically connected to the data source lines, output terminals of the switching elements being electrically connected to the data signal lines, and control terminals of the switching elements being electrically connected to the gating control lines; and
the plurality of gating control lines are configured to control the N switching elements of each of the gating units to be turned on in a time-sharing manner.

3. The display panel according to claim 2, wherein the N switching elements of each of the gating units are electrically connected to Q of the gating control lines of the multiplexer circuit, respectively, and Q≤N.

4. The display panel according to claim 2, wherein the multiplexer circuit comprises the first one to the N-th one of the gating control lines;
the gating units each comprise the first one to the N-th one of the switching elements; and
the control terminals of the i-th ones of the switching elements of the plurality of gating units are electrically connected to the i-th one of the gating control lines, where 1≤i≤N.

5. The display panel according to claim 4, wherein the i-th ones of the switching elements of the plurality of gating units which are electrically connected to the i-th one of the gating control lines are all N-type transistors; or
the i-th ones of the switching elements of the plurality of gating units which are electrically connected to the i-th one of the gating control lines are all P-type transistors.

6. The display panel according to claim 1, wherein the plurality of sub-pixels comprise first color sub-pixels, second color sub-pixels, and third color sub-pixels of different colors.

7. The display panel according to claim 6, wherein the display panel comprises a first pixel row and a second pixel row which are alternately arranged along the first direction and a first pixel column and a second pixel column which are alternately arranged along the second direction;
the first pixel row comprises a plurality of the first color sub-pixels which are arranged along the second direction;
the second pixel row comprises the second color sub-pixels and the third color sub-pixels which are alternately arranged along the second direction;
the first pixel column comprises a plurality of the first color sub-pixels which are arranged along the first direction; and
the second pixel column comprises the second color sub-pixels and the third color sub-pixels which are alternately arranged along the first direction.

8. The display panel according to claim 7, wherein the plurality of data signal lines comprise a first data signal line, a second data signal line, and a third data signal line;
the first data signal line is provided correspondingly to and electrically connected to the first pixel column; and
in the second pixel column, the second color sub-pixels are electrically connected to the second data signal line, and the third color sub-pixels are electrically connected to the third data signal line.

9. The display panel according to claim 8, wherein one of the data signal lines is provided correspondingly to one column of the sub-pixels;
the second data signal line is electrically connected to a plurality of the second color sub-pixels in corresponding one of the second pixel columns and is further electrically connected to a plurality of the second color sub-pixels in the second pixel column which is adjacent to the second data signal line; and
the third data signal line is electrically connected to a plurality of the third color sub-pixels in corresponding one of the second pixel columns and is further electrically connected to a plurality of the third color sub-pixels in the second pixel column which is adjacent to the third data signal line.

10. The display panel according to claim 7, wherein the plurality of data signal lines comprise a first data signal line and a second data signal line;
one of the data signal lines is provided correspondingly to one column of the sub-pixels;
the first data signal line is provided correspondingly to and electrically connected to the first pixel column; and
the second data signal line is provided correspondingly to and electrically connected to the second pixel column.

11. The display panel according to claim 10, wherein the plurality of gating units comprise a first gating unit and a second gating unit;
N output terminals of the first gating unit are electrically connected to N of the first data signal lines, respectively; and
N output terminals of the second gating unit are electrically connected to N of the second data signal lines, respectively.

12. The display panel according to claim 6, wherein the display panel comprises a first pixel column, a second pixel column, and a third pixel column which are alternately arranged along the second direction;
the first pixel column comprises a plurality of the first color sub-pixels which are arranged along the first direction; and
the second pixel column comprises a plurality of the second color sub-pixels which are arranged along the first direction; and
the third pixel column comprises a plurality of the third color sub-pixels which are arranged along the first direction.

13. The display panel according to claim 12, wherein the plurality of data signal lines comprise a first data signal line, a second data signal line, and a third data signal line;
one of the data signal lines is provided correspondingly to and electrically connected to one column of the sub-pixels;
the first data signal line is provided correspondingly to and electrically connected to the first pixel column; and
the second data signal line is provided correspondingly to and electrically connected to the second pixel column; and
the third data signal line is provided correspondingly to and electrically connected to the third pixel column.

14. The display panel according to claim 8, wherein the plurality of gating units comprise a first gating unit, a second gating unit, and a third gating unit;
N output terminals of the first gating unit are electrically connected to the N of the first data signal lines, respectively;
N output terminals of the second gating unit are electrically connected to the N of the second data signal lines, respectively; and
The N output terminals of the third gating unit are electrically connected to N of the third data signal lines, respectively.

15. The display panel according to claim 1, wherein the multiplexer circuit comprises a redundant gating unit which is electrically connected to Na of the data signal lines, where Na<N; and
the redundant gating unit comprises Na first-type switching elements, and output terminals of the Na first-type switching elements are electrically connected to the Na of the data signal lines, respectively.

16. The display panel according to claim 15, wherein the redundant gating unit further comprises Nb compensation switching elements, where Nb≤Na, Na+Nb≤N; and
output terminals of the Nb compensation switching elements are electrically connected to Nb of the Na of the data signal lines, respectively.

17. The display panel according to claim 16, wherein the first-type switching element and the compensation switching element which are connected to a same one of the data signal lines are turned on in a time sharing manner.

18. The display panel according to claim 6, wherein four of the first color sub-pixels form a first virtual quadrilateral, the first color sub-pixels are located at vertexes of the first virtual quadrilateral, and the second color sub-pixel or the third color sub-pixel is located in the first virtual quadrilateral; and
two of the second color sub-pixels and two of the third color sub-pixels form a second virtual quadrilateral, the second color sub-pixels are located at first vertexes of the second virtual quadrilateral, the third color sub-pixels are located at second vertexes of the second virtual quadrilateral, the first vertexes and the second vertexes are alternated and spaced apart from each other, and the first color sub-pixel is located in the second virtual quadrilateral.

19. The display panel according to claim 18, wherein the first color sub-pixels are green light-emitting elements; and
the second color sub-pixels and the third color sub-pixels are red light-emitting elements and blue light-emitting elements, respectively.

20. A display apparatus comprising the display panel, comprising:
a plurality of data signal lines and a plurality of sub-pixels, the plurality of data signal lines extending along a first direction and being arranged along a second direction intersecting with the second direction, and the data signal lines being electrically connected to the plurality of sub-pixels;
a plurality of data source lines extending along the first direction and arranged along the second direction;
a multiplexer circuit comprising a plurality of gating units which each comprise one input terminal and N output terminals, the input terminals of the gating units being electrically connected to the data source lines, and the N output terminals of each of the gating units being electrically connected to N of the data signal lines, respectively, where N≥2; and
at least one of the gating units satisfying a case that the N of the data signal lines are electrically connected to a plurality of the sub-pixels of a same color.
